(19) United States
(12) Patent Application Publication
(10) Pub. No.: US 2024/0338790 A1
(43) Pub. Date: Oct. 10, 2024

(54) APPARATUS AND METHOD FOR CHANGING SIZE OF IMAGE

(71) Applicant: SAMSUNG ELECTRONICS CO., LTD., Suwon-si (KR)

(72) Inventors: Jookwan LEE, Suwon-si (KR); Yongjin KWON, Suwon-si (KR); Junyoung CHOI, Suwon-si (KR); Yangwook KIM, Suwon-si (KR); Soyoung LEE, Suwon-si (KR); Junghyeob LEE, Suwon-si (KR)

(21) Appl. No.: 18/748,867

(22) Filed: Jun. 20, 2024

Related U.S. Application Data
(63) Continuation of application No. PCT/KR2022/018545, filed on Nov. 23, 2022.

(30) Foreign Application Priority Data
Jan. 12, 2022 (KR) 10-2022-0004523
Feb. 11, 2022 (KR) 10-2022-0018071

(51) Int. Cl. G06T 3/40

(52) U.S. Cl. CPC G06T 3/40

(57) ABSTRACT

An electronic device may include: a display module capable of changing the size of a display screen; a memory in which computer-executable instructions are stored; and a processor which accesses the memory and executes the instructions, wherein, when the size of the display screen is changed while displaying an image and a first navigation bar, the processor terminates output of the first navigation bar and initiates output of a second navigation bar; and changes the size of the image while maintaining an image ratio on the display screen.

### CROSS-REFERENCE TO RELATED APPLICATIONS

This application is a continuation application of International Application No. PCT/KR2022/018545 designating the United States, filed on Nov. 23, 2022, in the Korean Intellectual Property Receiving Office and claiming priority to Korean Patent Application No. 10-2022-0004523, filed on Jan. 12, 2022 and Korean Patent Application No. 10-2022-0018071, filed on Feb. 11, 2022, in the Korean Intellectual Property Office, the disclosures of which are all hereby incorporated by reference herein in their entireties.

### BACKGROUND

### 1. Field

The following description relates to a method for changing the size of an image and displaying the image.

### 2. Description of Related Art

Various electronic devices, such as smartphones, tablet personal computers (PCs), portable multimedia players (PMPs), personal digital assistants (PDAs), laptop PCs, and wearable devices, have been widely used. In addition, rollable type electronic devices with a flexible display that may bend have also been popular these days.

An electronic device may display an image on a screen of a display. When a screen ratio of the electronic device does not match an image ratio of the image, there may be a margin area where the image is not displayed on a left, right, upper, or lower side of the screen. In addition, when the electronic device is a rollable type, the size of a display screen viewed from one side may increase. In this case, when the image ratio of the image is fixed, only the margin area increases while the size of the image does not increase as the size of the display screen increases.

### SUMMARY

According to an example embodiment, an electronic device may include a display module, comprising a display, configured to change a size of a display screen, a memory configured to store computer-executable instructions, and at least one processor, comprising processing circuitry, configured to execute the computer-executable instructions by accessing the memory, in which the at least one processor is individually and/or collectively configured to, when the size of the display screen changes while displaying an image and a first navigation bar, terminate an output of the first navigation bar and initiate an output of a second navigation bar and change a size of the image while maintaining an image ratio.

According to an example embodiment, a method implemented by a processor may include displaying an image and a first navigation bar, when a size of a display screen of a display module changes while displaying the image and the first navigation bar, terminating an output of the first navigation bar and initiating an output of a second navigation bar, and changing a size of the image while maintaining an image ratio on the display screen.

### Effects

According to an example embodiment, an electronic device may increase the size of an image while maintaining an image ratio of the image within a limited screen size by terminating an output of a first navigation bar and initiating an output of a second navigation bar.

According to an example embodiment, the electronic device may allow a user to recognize the image further conveniently by expanding a display screen while maintaining the image ratio in a state in which the second navigation bar is output such that the image has a maximum and/or high expandable size.

### BRIEF DESCRIPTION OF DRAWINGS

The above and other aspects, features, and advantages of certain example embodiments will be more apparent from the following detailed description, taken in conjunction with the accompanying drawings, in which:

FIG. 1 is a block diagram illustrating an electronic device in a network environment, according to various example embodiments.

FIGS. 2A and 2B are front perspective views of an electronic device in a closed state and an open state, according to various example embodiments.

FIGS. 2C and 2D are rear perspective views of the electronic device in a closed state and an open state, according to various example embodiments.

FIG. 3 is a flowchart illustrating an operation of changing the size of an image, according to an example embodiment.

FIG. 4 is a diagram illustrating the expansion of an image and the display of a second navigation bar, according to an example embodiment.

FIGS. 5 and 6 are diagrams illustrating an example of image expansion in a portrait view mode, according to an example embodiment.

FIG. 7 is a diagram illustrating another example of image expansion in a portrait view mode, according to an example embodiment.

FIG. 8 is a diagram illustrating an example of image expansion in a landscape view mode, according to an example embodiment.

FIG. 9 is a flowchart illustrating an operation of an electronic device expanding an image, according to an example embodiment.

FIG. 10 is a diagram illustrating image expansion based on a user input, according to an example embodiment.

FIG. 11 is a diagram illustrating image expansion in a multi-window environment, according to an example embodiment.

FIG. 12 is a diagram illustrating a method of further expanding an image, according to an example embodiment.

### DETAILED DESCRIPTION

Hereinafter, example embodiments will be described in detail with reference to the accompanying drawings. When describing the embodiments with reference to the accompanying drawings, like reference numerals refer to like elements and a repeated description related thereto will be omitted.

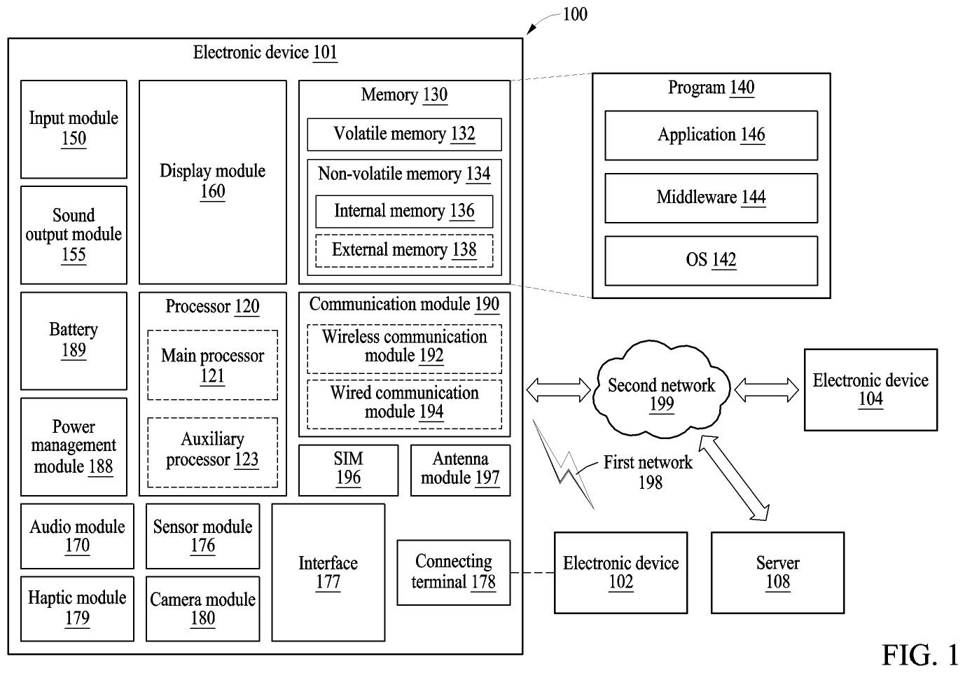

FIG. 1 is a block diagram illustrating an electronic device 101 in a network environment 100, according to various embodiments. Referring to FIG. 1, the electronic device 101 in the network environment 100 may communicate with an electronic device 102 via a first network 198 (e.g., a short-range wireless communication network) or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected, directly or indirectly, to the processor 120 and may perform various data processing or computations. According to an embodiment, as at least a part of data processing or computations, the processor 120 may store a command or data received from another component (e.g., the sensor module 176 or the communication module 190 comprising communication circuitry) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from or in conjunction with the main processor 121. For example, when the electronic device 101 may include the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specifically for artificial intelligence model processing. An artificial intelligence model may be generated by machine learning. The machine learning may be performed by, for example, the electronic device 101, in which artificial intelligence is performed, or performed via a separate server (e.g., the server 108). Learning algorithms may include, but are not limited to, for example, supervised learning, unsupervised learning, semi-supervised learning, or reinforcement learning. The artificial intelligence model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), and a deep Q-network or a combination of two or more thereof but is not limited thereto. The artificial intelligence model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and May include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, or the projector. According to an embodiment, the display module 160 may include a touch sensor adapted to detect a touch, or a pressure sensor adapted to measure the intensity of force incurred by the touch.

The audio module 170 may convert a sound into an electric signal or vice versa. According to an embodiment, the audio module 170 may obtain the sound via the input module 150 or output the sound via the sound output module 155 or an external electronic device (e.g., the electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101 and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used by the electronic device 101 to couple with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may physically connect to an external electronic device (e.g., the electronic device 102). According to an embodiment, the connecting terminal 178 may include, for example, an HDMI connector, a USB connector, an SD card connector, or an audio connector (e.g., a headphones connector).

The haptic module 179 may convert an electric signal into a mechanical stimulus (e.g., a vibration or a movement) or an electrical stimulus, which may be recognized by a user via their tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, image signal processors, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell, which is not rechargeable, a secondary cell, which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip) or may be implemented as multi-components (e.g., multi-chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196. For reference, the communication module may establish communication with a target device (e.g., the electronic device 104) for mirroring display.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., an antenna array). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mm Wave antenna module. According to an embodiment, the mmWave antenna module may include a PCB, an RFIC on a first surface (e.g., the bottom surface) of the PCB, or adjacent to the first surface of the PCB and capable of supporting a designated high-frequency band (e.g., a mm Wave band), and a plurality of antennas (e.g., array antennas) arranged on a second surface (e.g., the top or a side surface) of the PCB, or adjacent to the second surface of the PCB and capable of transmitting or receiving signals of the designated high-frequency band.

At least some of the above-described components may be coupled mutually and exchange signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device (e.g., the electronic device 104) via the server 108 coupled, directly or indirectly, with the second network 199. Each of the external electronic devices (e.g., the electronic device 102 or 104) may be a device of the same type as or a different type from the electronic device 101. According to an embodiment, all or some of operations to be executed by the electronic device 101 may be executed by one or more external electronic devices (e.g., the electronic devices 102 and 104 and the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or service. The one or more external electronic devices receiving the request may perform the at least part of the function or service, or an additional function or an additional service related to the request and may transfer a result of the performance to the electronic device 101. The electronic device 101 may provide the result, with or without further processing the result, as at least part of a response to the request. To that end, cloud computing, distributed computing, mobile edge computing (MEC), or client-server computing technology may be used, for example. The electronic device 101 may provide ultra-low-latency services using, e.g., distributed computing or MEC. The external electronic device 104 may be a target device with a target display that may output an image. In another embodiment, the external electronic device (e.g., the electronic device 104) may include an Internet-of-things (IoT) device. The server 108 may be an intelligent server using machine learning and/or a neural network. According to an embodiment, the external electronic device (e.g., the electronic device 104) or the server 108 may be included in the second network 199. The electronic device 101 may be applied to intelligent services (e.g., smart home, smart city, smart car, or healthcare) based on 5G communication technology or IoT-related technology.

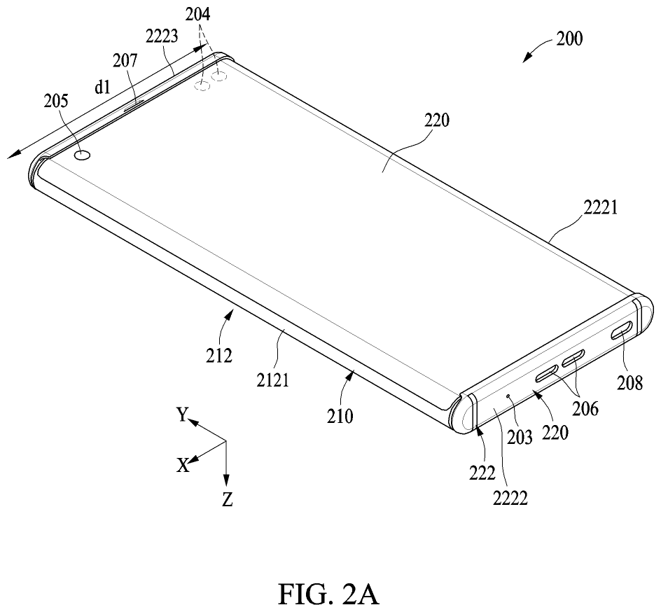

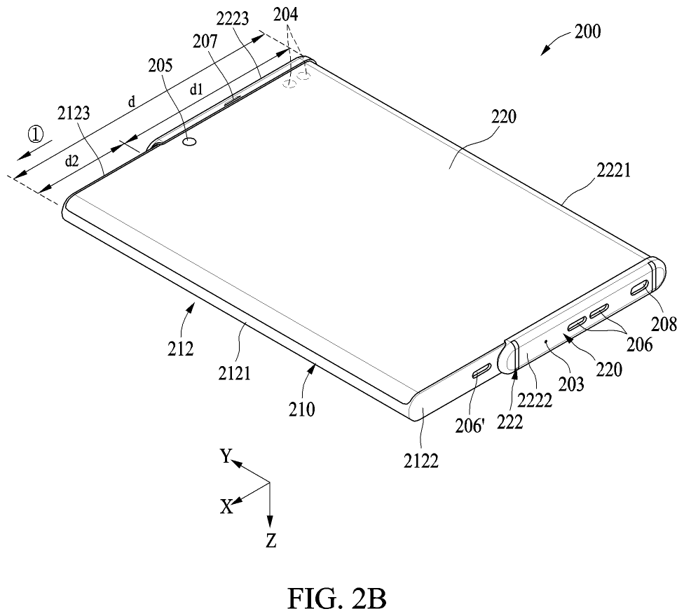

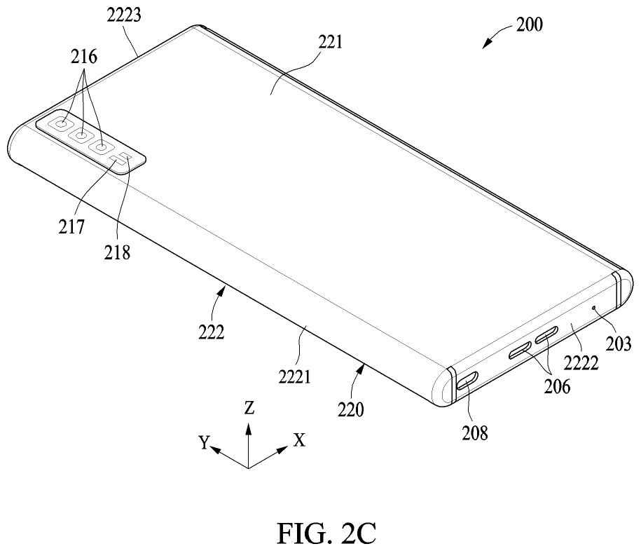

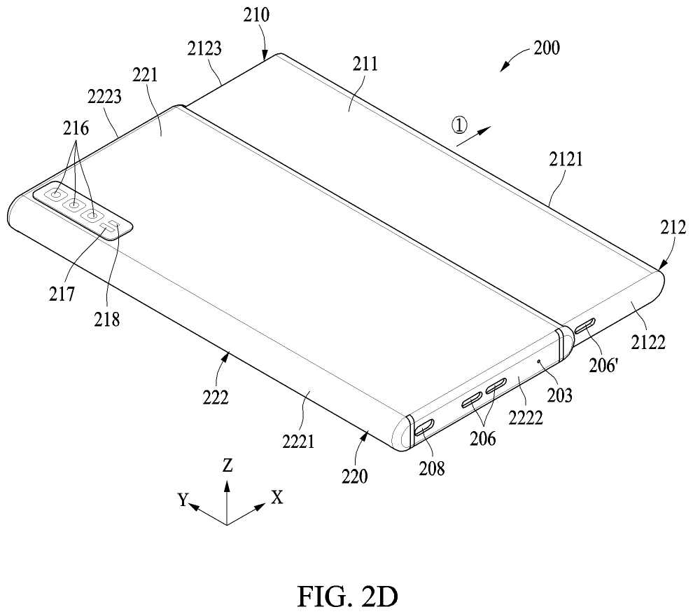

FIGS. 2A and 2B are front perspective views illustrating an electronic device 200 in a closed state and an open state, according to an embodiment. FIGS. 2C and 2D are rear perspective views of the electronic device 200 in a closed state and an open state, according to various embodiments.

The electronic device 200 of FIG. 2A may be at least partially similar to the electronic device 101 of FIG. 1 or may further include other embodiments of an electronic device.

Referring to FIGS. 2A to 2B, the electronic device 200 may include a first housing 210 and a second housing 220 that is at least partially movably coupled, directly or indirectly, to the first housing 210. According to an embodiment, the first housing 210 may include a first plate 211 and a first side frame 212 that extends in a substantially vertical direction (e.g., a z-axis direction) along an edge of the first plate 211. According to an embodiment, the first side frame 212 may include a first side surface 2121, a second side surface 2122 extending from one edge of the first side surface 2121, and a third side surface 2123 extending from the other edge of the first side surface 2121. According to an embodiment, the first housing 210 may include a first space that is at least partially closed from the outside by the first plate 211 and the first side frame 212.

According to an embodiment, the second housing 220 may include a second plate 221, and a second side frame 222 that extends in a substantially vertical direction (e.g., the z-axis direction) along an edge of the second plate 221. According to an embodiment, the second side frame 222 may include a fourth side surface 2221 facing away from the first side surface 2121, a fifth side surface 2222 extending from one end of the fourth side surface 2221 and at least partially coupled, directly or indirectly, to the second side surface 2122, and a sixth side surface 2223 extending from the other end of the fourth side surface 2221 and at least partially coupled, directly or indirectly, to the third side surface 2123. In an embodiment, the fourth side surface 2221 may extend from a structure other than the second plate 221 and may also be coupled, directly or indirectly, to the second plate 221. According to an embodiment, the second housing 220 may include a second space that is at least partially closed from the outside by the second plate 221 and the second side frame 222. According to an embodiment, the first plate 211 and the second plate 221 may be arranged to form a rear surface of the electronic device 200 at least partially. For example, the first plate 211, the second plate 221, the first side frame 212, and the second side frame 222 may be formed of, for example, a polymer, coated or colored glass, ceramic, metal (e.g., aluminum, stainless steel (STS), or magnesium), or a combination of two or more of the above materials.

According to an embodiment, the electronic device 200 may include a flexible display 230 arranged to be supported by the first housing 210 and the second housing 220. According to an embodiment, the flexible display 230 may include a flat portion supported by the second housing 220, and a bendable portion extending from the flat portion and supported by the first housing 210. According to an embodiment, the bendable portion of the flexible display 230 may be arranged in the first space of the first housing 210 so as not to be exposed to the outside when the electronic device 200 is closed and may be exposed to the outside to extend from the flat portion while being supported by the first housing 210 when the electronic device 200 is open. Accordingly, the electronic device 200 may be a rollable electronic device in which a display screen of the flexible display 230 expands in response to an open operation according to a movement of the first housing 210 from the second housing 220.

According to an embodiment, in the electronic device 200, the first housing 210 may be at least partially inserted into the second space of the second housing 220, and may be coupled to be movable in direction (1). For example, in the closed state, the electronic device 200 may be maintained in a state in which the first housing 210 and the second housing 220 are coupled, directly or indirectly, such that a distance between the first side surface 2121 and the fourth side surface 2221 is a first distance d1. According to an embodiment, in the open state, the electronic device 200 may be maintained in a state in which the first housing 210 protrudes from the second housing 220 to have a second interval distance d in which the first side surface 2121 protrudes from the fourth side surface 2221 by a predetermined distance d2. According to an embodiment, the flexible display 230 may be supported by the first housing 210 and/or the second housing 220 such that both ends thereof have curved edges in the open state.

According to an embodiment, the electronic device 200 may automatically transition between the open state and the closed state by a driving unit arranged in the first space and/or the second space. For example, a processor (e.g., the processor 120 of FIG. 1) of the electronic device 200 may be configured to control an operation of the first housing 210 using the driving unit when an event for a transition between the open state and the closed state of the electronic device 200 is detected. In another embodiment, the first housing 210 may manually protrude from the second housing 220 through a user's manipulation. In this case, the first housing 210 may protrude by a protrusion amount desired by the user, and thus, the display sizes of a screen of the flexible display 230 may vary. Accordingly, the processor (e.g., the processor 120 of FIG. 1) of the electronic device 200 may display an object in various ways corresponding to a display area corresponding to a predetermined protrusion amount of the first housing 210 and may control the execution of an application program.

According to an embodiment, the electronic device 200 may include at least one of an input device 203, sound output devices 206 and 207, sensor modules 204 and 217, camera modules 205 and 216, a connector port 208, a key input device (not shown), or an indicator (not shown). In another embodiment, at least one of the components described above of the electronic device 200 may be omitted, or the electronic device 200 may further include other components.

According to an embodiment, the input device 203 may include a microphone 203. In an embodiment, the input device 203 may include a plurality of microphones 203 arranged to sense a direction of sound. The sound output devices 206 and 207 may include speakers 206 and 207. The speakers 206 and 207 may include an external speaker 206 and a phone call receiver 207. In an example embodiment, when an external speaker 206′ is arranged in the first housing 210, sound may be output through a hole of the speaker 206 formed in the second housing 220 in the closed state. According to an embodiment, the microphone 203 and the connector port 208 may also be formed to have substantially the same configuration. In another embodiment, the sound output devices 206 and 207 may include a speaker (e.g., a piezo speaker) that operates without a separate speaker hole 206.

According to various embodiments, the sensor modules 204 and 217 may generate an electrical signal or a data value corresponding to an internal operating state of the electronic device 200 or an external environmental state. The sensor modules 204 and 217 may include, for example, a first sensor module 204 (e.g., a proximity sensor or an illuminance sensor) arranged on a front surface of the second housing 220, and/or a second sensor module 217 (e.g., an HRM sensor) arranged on a rear surface of the second housing 220. According to an embodiment, the first sensor module 204 may be arranged below the flexible display 230 in the second housing 220. According to an embodiment, the first sensor module 204 may further include at least one of a proximity sensor, an illuminance sensor 204, a time of flight (TOF) sensor, an ultrasonic sensor, a fingerprint recognition sensor, a gesture sensor, a gyro sensor, an atmospheric pressure sensor, a magnetic sensor, an acceleration sensor, a grip sensor, a color sensor, an IR sensor, a biometric sensor, a temperature sensor, or a humidity sensor.

According to an embodiment, the camera devices 205 and 216 may include a first camera device 205 arranged on the front surface of the second housing 220 of the electronic device 200, and a second camera device 216 arranged on the rear surface of the second housing 220. According to an embodiment, the electronic device 200 may include a flash 218 located near the second camera device 216. According to an embodiment, the camera devices 205 and 216 may include one or more lenses, an image sensor, and/or an ISP. According to an embodiment, the first camera device 205 may be arranged under the flexible display 230 and may be configured to capture an object through a portion of an active area of the flexible display 230. According to an embodiment, the flash 218 may include, for example, a light-emitting diode (LED) or a xenon lamp. In one embodiment, two or more lenses (e.g., a wide-angle lens and a telephoto lens) and image sensors may be arranged on one surface of the electronic device 200.

According to an embodiment, the electronic device 200 may include at least one antenna (not shown). According to an embodiment, the at least one antenna may wirelessly communicate with an external electronic device (e.g., the electronic device 104 of FIG. 1), or may wirelessly transmit and receive the power required for charging. According to an embodiment, the antenna may include a legacy antenna, a mmWave antenna, a near field communication (NFC) antenna, a wireless charging antenna, and/or a magnetic secure transmission (MST) antenna. According to an embodiment, an antenna structure may be formed through at least a portion of the first side frame 212 and/or the second side frame 222, which are formed of metal.

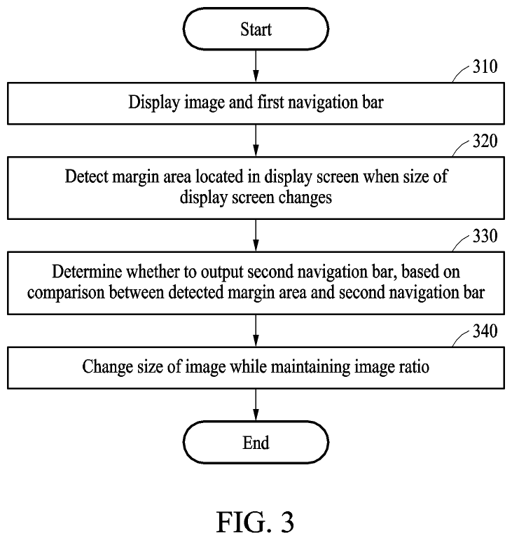

FIG. 3 is a flowchart illustrating an operation of changing the size of an image, according to an embodiment.

An electronic device (e.g., the electronic device 101 of FIG. 1) according to an embodiment may display the image and change the size of the image. For example, the electronic device may increase or decrease the size of the image. The electronic device may increase the size of the image, based on an increase of the size of a display screen. The electronic device may decrease the size of the image, based on a decrease in the size of a display screen.

The electronic device may display the image and a first navigation bar. When the size of the display screen changes while displaying the image and the first navigation bar, the electronic device may terminate an output of the first navigation bar and may initiate an output of a second navigation bar. The electronic device may change the size of the image while maintaining an image ratio in the display screen. The image ratio may be a ratio of a length (e.g., a height in a portrait view mode) along a second axis of the image to a length (e.g., a width in a portrait view mode) along a first axis of the image. In this case, the first axis may be an axis representing an axis that is parallel to a first direction in which the display screen of the electronic device expands, and the second axis may be an axis that is orthogonal to the first axis. A navigation bar may be a graphic object including various icons, such as a home icon, a back icon, or an icon through which a recently used application is verified. The first navigation bar may be a navigation bar that is displayed along the first axis and the second navigation bar may be a navigation bar that is displayed along the second axis. For example, the navigation bar displayed along the first axis may be a navigation bar of which the length along the first axis is greater than the length along the second axis, and the navigation bar displayed along the second axis may be a navigation bar of which the length along the second axis is greater than the length along the first axis. Hereinafter, the operation of the electronic device changing the size of the image according to a size change of the display screen is further described in detail.

First, in operation 310, the electronic device may display the image and the first navigation bar on the display screen. The electronic device may display the image in an application area. The application area may be an area where the content (e.g., an image) of the application may be displayed. Based on an increase in the size of the display screen of the electronic device, the size of the application area and the size of a first navigation bar area may also increase. In this case, the first navigation bar area may be an area where the first navigation bar is displayed.

In operation 320, the electronic device may detect a margin area located in the display screen when the size of the display screen changes while displaying the image and the first navigation bar. In this case, the margin area may be a remaining area excluding an area where the image is displayed of the application area. For example, the electronic device may display the margin area in black or in a color similar to the image displayed on the screen. The color similar to the image may be, for example, an average color of pixels included by the image, but the color is not limited thereto.

In operation 330, the electronic device may determine whether to output the second navigation bar, based on a comparison between the detected margin area and the second navigation bar. For example, the electronic device may determine whether to output the second navigation bar by comparing the length along the first axis of the margin area with a first axis length of the second navigation bar.

In operation 340, when determining to output the second navigation bar, the electronic device may terminate the output of the first navigation bar and initiate the output of the second navigation bar and may change the size of the image while maintaining the image ratio in the display screen. For example, the electronic device may increase the size of the image while maintaining the image ratio by using the first navigation bar area where the first navigation bar has been displayed. The electronic device may increase the size of the image by displaying a portion of the image in a portion of the first navigation bar area.

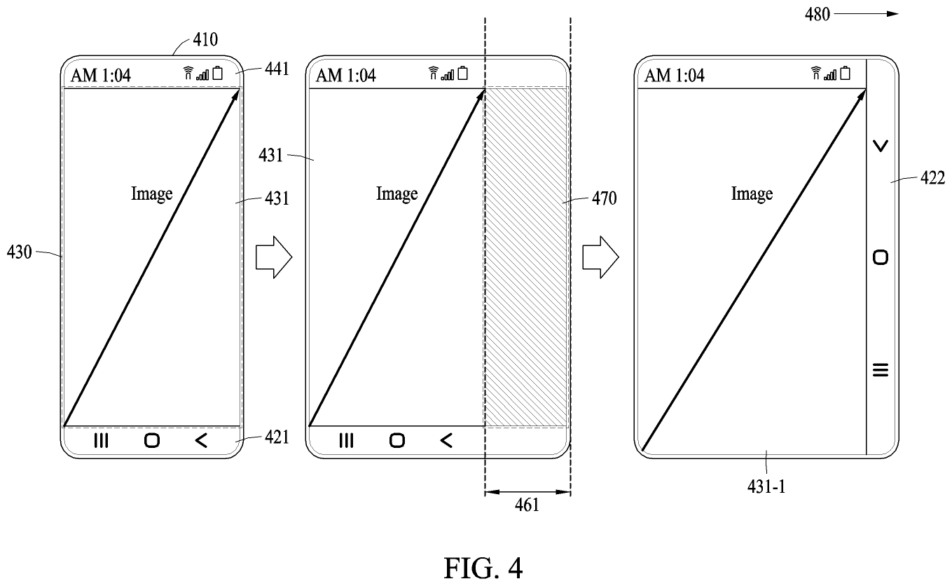

FIG. 4 is a diagram illustrating the expansion of an image and the display of a second navigation bar, according to an embodiment.

According to an embodiment, an electronic device 410 (e.g., the electronic device 101 of FIG. 1) may display a navigation bar (e.g., a first navigation bar 421 or a second navigation bar 422), an image 431, and a notification bar 441. The notification bar 441 may also be referred to as a status bar, which may display various types of status information of an electronic device. An application area 430 may represent a remaining area excluding an area (hereafter, a notification bar area) where a notification bar is displayed and an area (hereafter, a navigation bar area) where the navigation bar is displayed in a whole screen area.

In FIG. 4, for ease of description, an operation of the electronic device 410 in a portrait view mode is mainly described, but an operation of an electronic device in a landscape view mode is similar. The electronic device 410 may display the image 431 in the application area 430. For example, when an image ratio of the image 431 matches a screen ratio of the electronic device 410, there may be no margin area. When the image ratio of the image 431 does not match the screen ratio of the electronic device 410, there may be a margin area from before a display screen is expanded. In this case, the screen ratio of an electronic device may be a ratio of a length along a first axis of an application area to a length along a second axis of the application area. As described above, the first axis may be an axis that is parallel to a first direction 480 in which the display screen of the electronic device expands, and the second axis may be an axis that is orthogonal to the first axis. The size of the application area may also increase based on an increase of the size of the display screen. When the size of the application area increases, the screen ratio of the electronic device may also change.

When the display screen expands in the first direction 480, the electronic device 410 may expand the first navigation bar 421 in the first direction. For example, based on the expansion of the display screen, the electronic device may increase the length (e.g., a width) along the first axis of the first navigation bar 421 by a length 461 of the display screen expanding in the first direction 480 and may constantly maintain the length (e.g., a height) along the second axis of the first navigation bar 421. Likewise, when the display screen expands in the first direction, the electronic device 410 may increase the length (e.g., a width) along the first axis of the notification bar 441 by the length 461 of the display screen expanding in the first direction 480 and may constantly maintain the length (e.g., a height) along the second axis of the notification bar 441.

When the display screen of the electronic device 410 expands in the first direction 480, the screen ratio of the electronic device may change. Since the electronic device 410 expands the image 431 while maintaining the image ratio, a margin area 470 may be generated when the image ratio of the image 431 gets different from the screen ratio of the electronic device. The application area 430 of the electronic device 410 may expand by the generated margin area 470. The electronic device 410 may determine whether to output the second navigation bar 422 on the display screen, based on a comparison between the margin area 470 and the second navigation bar 422.

When determining to output the second navigation bar 422, the electronic device 410 may terminate an output of the first navigation bar 421 and initiate an output of the second navigation bar 422. For example, the electronic device 410 may delete the first navigation bar 421 and display the second navigation bar 422. The electronic device 410 may terminate the output of the first navigation bar 421 and may expand and display the image 431 by using a first navigation bar area where the first navigation bar 421 has been displayed. With it terminating the output of the first navigation bar 421, the electronic device 410 may display a portion of an expanded image 431-1 in a portion of the first navigation bar area. For example, the electronic device 410 may increase a second axis length of the image 431 by a length along the second axis of the first navigation bar area. In addition, the electronic device 410 may use the margin area 470 to display the second navigation bar 422. The electronic device 410 may display the second navigation bar 422 by using the margin area 470. The electronic device 410 may display a portion of the second navigation bar 422 in a portion of the margin area 470.

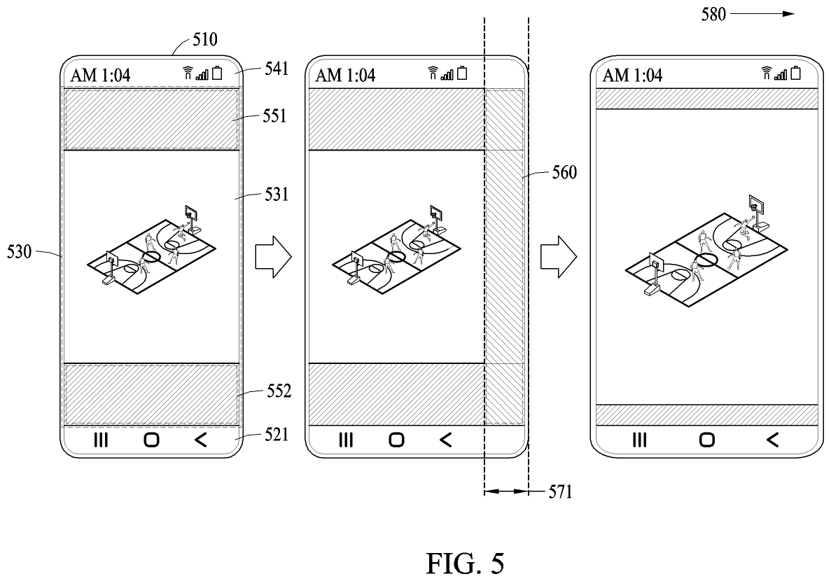

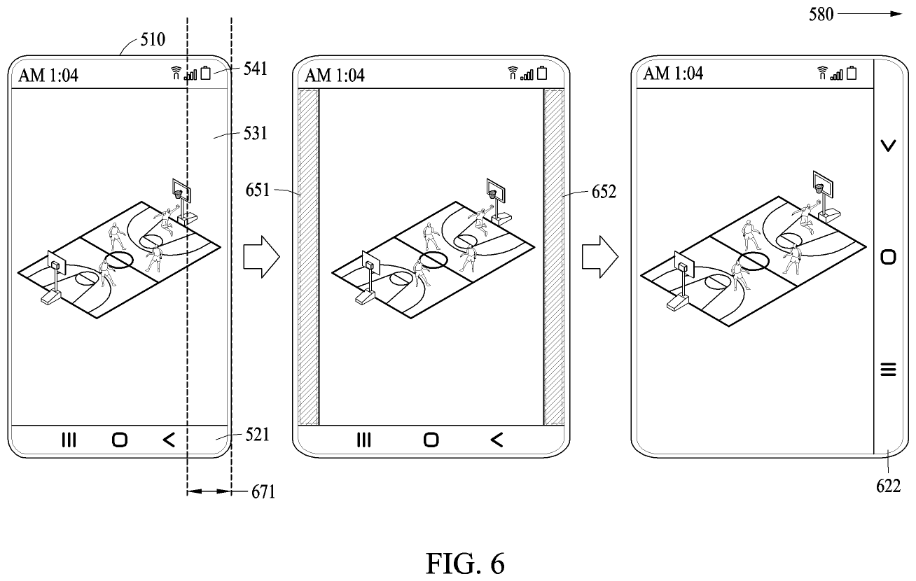

FIGS. 5 and 6 are diagrams illustrating an example of image expansion in a portrait view mode, according to an embodiment.

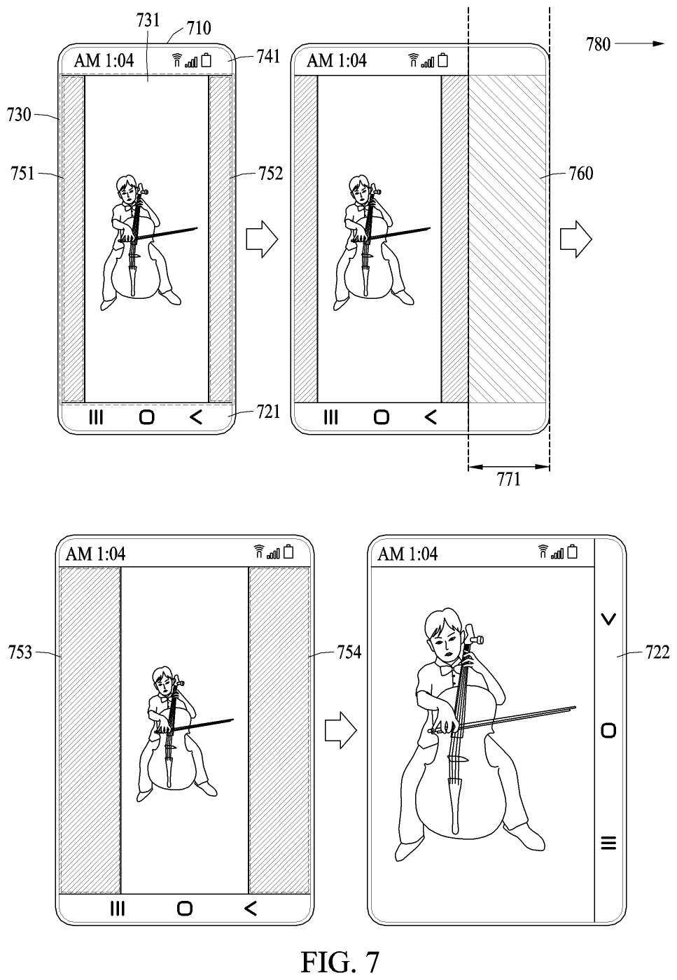

According to an embodiment, an electronic device 510 (e.g., the electronic device 101 of FIG. 1) may be in a portrait view mode. A display screen of the electronic device 510 may expand in a first direction 580 (e.g., a direction from left to right). The electronic device 510, before the display screen expands, may display a first navigation bar 521, an image 531, and a notification bar 541. When the electronic device 510 is in the portrait view mode, the notification bar 541 and the first navigation bar 521 may be displayed along a first axis. When an image ratio of the image 531 does not match a screen ratio of the electronic device 510 before the display screen expands, from before the display screen expands, there may be margin areas 551 and 552 in the electronic device 510. FIGS. 5 and 6 illustrate a process of the electronic device 510 expanding an image when the image ratio of the image 531 is greater than the screen ratio of the electronic device 510 before the display screen expands. FIG. 7 illustrates image expansion when an image ratio of an image is less than a screen ratio of an electronic device before the display screen expands as described below.

As illustrated in FIG. 5, when the image ratio of the image 531 is greater than the screen ratio of the electronic device 510 before the display screen expands, a margin area may be generated on a second axis based on the image 531 in an application area 530. For example, when the electronic device 510 displays the image 531 such that the center of the image 531 matches the center of the application area 530, the margin areas 551 and 552 may be generated respectively in an upper side of the image 531 and a lower side of the image 531 of the application area 530.

When the display screen expands in the first direction 580, the electronic device 510 may determine whether the size of the image 531 may increase while maintaining the image ratio. When the margin areas 551 and 552 are on the second axis (e.g., the upper or lower side of the image 531) based on the image 531 of the application area 530, the electronic device 510 may determine that the size of the image 531 may increase as the display screen expands in the first direction. When the display screen of the electronic device 510 expands in the first direction 580, the length (e.g., a height) along the second axis may be maintained as the same as before while the length (e.g., a width) along the first axis increases. The electronic device 510 may increase the length along the second axis of the image 531 by using the margin areas 551 and 552. In addition, since the application area 530 expands by an additional area 560 corresponding to a length 571 expanding in the first direction, the electronic device 510 may increase the length along the first axis of the image 531 by displaying a portion of the image 531 in the additional area 560. In other words, when the margin areas 551 and 552 are in the upper or lower side of the image 531 in the portrait view mode, the electronic device 510 may determine that the size of the image 531 may increase while maintaining the image ratio by using the margin areas 551 and 552 as the display screen expands in the first direction 580. Furthermore, the display screen of the electronic device 510 may expand in the first direction 580 such that there may not be the margin areas 551 and 552 in the upper or lower side of the image 531.

As illustrated in FIG. 6, when the display screen expands by a first expansion length 671 in the first direction 580, the electronic device 510 may expand the image 531 to have a first expansion size, which may be a maximum and/or high expandable size in a state in which the first navigation bar 521 is displayed. The first expansion length may be a minimum expansion length in the first direction 480 of the display screen such that the image 531 may have the first expansion size which may be a maximum and/or high expandable size while maintaining the image ratio in a state in which the first navigation bar 521 is displayed. When the display screen expands by the first expansion length 671 in the first direction 580, a margin area may not be generated in the display screen as the image ratio of the image 531 matches the screen ratio of the electronic device 510.

When the display screen expands exceeding the first expansion length 671 in the first direction 580, the electronic device 510 may maintain the size of the image 531 in the first expansion size in a state in which the first navigation bar 521 is displayed. Since the margin area is not generated in the upper or lower side of the image 531 when the display screen expands by the first expansion length 671 in the first direction 580, the electronic device 510 may determine that the size of the image 531 may not further increase even though the display screen further expands exceeding the first expansion length 671 in the first direction 580. When the display screen of the electronic device 510 expands in the first direction 580, the length along the second axis of the application area 530 may be maintained as the same as before, and there may be no margin area in the upper or lower side of the image 531, and thus, the length along the second axis of the image 531 may not increase. In other words, when there may be no margin area on the second axis (e.g., the upper or lower side of the image 531) based on the image 531 of the application area 530, the electronic device 510 may determine that the size of the image 531 may not increase while maintaining the image ratio as the display screen expands in the first direction.

When the display screen of the electronic device 510 expands exceeding the first expansion length 671 in the first direction 580, the size of the image 531 may be maintained in the first expansion size, and a margin area may be generated on the first axis based on the image 531 of the application area 530. For example, when the electronic device 510 displays the image 531 such that the center of the image 531 matches the center of the application area 530, margin areas 651 and 652 may be generated respectively in left and right sides of the image 531 of the application area 530.

When the size of the display screen changes, the electronic device 510 may detect a margin area located in the display screen. For example, at each time when the size of the display screen changes, the electronic device 510 may detect a margin area located in the display screen. The electronic device 510 may determine whether to output a second navigation bar, based on a comparison between the detected margin area and the second navigation bar. When an image has the first expansion size representing a maximum expandable size of the image in a state in which a first navigation bar is displayed, the electronic device may compare the detected margin area with the second navigation bar. For example, when the image 531 has the first expansion size, the electronic device 510 may determine whether to output the second navigation bar by comparing the margin areas 651 and 652 detected within the display screen with a second navigation bar 622. For another example, when the image 531 has a size less than the first expansion size, the electronic device 510 may expand the image 531 while maintaining the image ratio in a state in which the first navigation bar 521 is displayed as the display screen expands, and thus may not perform a comparison between a margin area and the second navigation bar.

As described above, the electronic device 510 may determine whether to output the second navigation bar 622, based on a comparison between the margin areas 651 and 652 located within the display screen and the second navigation bar 622. The method of comparing the margin areas 651 and 652 with the second navigation bar 622 is described in detail below with reference to FIG. 7. When determining to output the second navigation bar 622 according to a result of the comparison between the margin areas 651 and 652 and the second navigation bar 622, the electronic device 510 may terminate an output of the first navigation bar 521 and initiate an output of the second navigation bar 622. When determining to output the second navigation bar 622, the electronic device 510 may further expand the image 531 having the first expansion size while maintaining the image ratio. For example, the electronic device 510 may expand the image 531 to a second expansion size such that the length along the second axis of the image 531 having the first expansion size may expand to the length along the second axis of an area where the first navigation bar 521 has been displayed while maintaining the image ratio. When determining to output the second navigation bar 622, the electronic device 510 may expand the image 531 having the first expansion size to have the second expansion size, which is a maximum expandable size of an image in a state in which the first navigation bar 521 is deleted and the second navigation bar 622 is displayed.

According to an embodiment, when determining to output the second navigation bar 622, the electronic device 510 may display the second navigation bar 622 by using a margin area detected within the display screen. For example, the electronic device 510 in the portrait view mode may display the second navigation bar 622 by using the margin areas 651 and 652 located in the left or right side of the image 531 of the application area 530. The electronic device 510 may display a portion of the second navigation bar 622 in a portion of the margin areas 651 and 652. For example, the electronic device 510 may display the second navigation bar 622 in the right side, that is, it may display a portion of the second navigation bar 622 in a portion of the margin area 651 located in the right side of the image 531. The electronic device 510 may also display the second navigation bar 622 in the left side, that is, it may display a portion of the second navigation bar 622 in a portion of the margin area 652 located in the left side of the image 531.

In addition, the electronic device 510 may terminate an output of the notification bar 541 to further increase the size of the image 531. For example, the electronic device 510 may terminate the output of the notification bar 541 by displaying an icon displayed on the notification bar 541 on the second navigation bar 622. In this case, the electronic device 510 may increase the size of the image 531 by expanding the length along the second axis of the image 531 by the length along the second axis of the notification bar 541.

FIG. 7 is a diagram illustrating another example of image expansion in a portrait view mode, according to an embodiment.

According to an embodiment, an electronic device 710 (e.g., the electronic device 101 of FIG. 1) may be in a portrait view mode. The electronic device 710, before a display screen expands, may display a first navigation bar 721, an image 731, and a notification bar 741. FIG. 7 illustrates a process of the electronic device 710 expanding an image when an image ratio of the image 731 is less than a screen ratio of the electronic device 710 before the display screen expands.

When the image ratio of the image 731 is less than the screen ratio of the electronic device 710 before the display screen expands, a margin area may be generated on a first axis that is parallel to a first direction 780, based on the image 731 in an application area 730. For example, when the electronic device 710 displays the image 731 such that the center of the image 731 matches the center of the application area 730, margin areas 751 and 752 may be generated respectively in left and right sides of the image 731 of the application area 730. As described above, when there is no margin area on a second axis (e.g., an upper or lower side of the image 731) based on the image 731 of the application area 730, the electronic device 710 may determine that the size of the image 731 may not increase as the display screen expands in the first direction 780. When the display screen of the electronic device 710 expands in the first direction 780, a length along the second axis of the application area 730 may be maintained as the same as before. In other words, when the image ratio of the image 731 is less than the screen ratio of the electronic device 710 before the display screen expands, the electronic device 710 may determine that the image 731 displayed before the display screen expands has a first expansion size, which is a maximum expandable size while maintaining the image ratio in a state in which the first navigation bar 721 is displayed.

Then, when the display screen expands in the first direction 780, the electronic device 710 may expand the application area 730 by an additional area 760 corresponding to an extended length 771. Since the electronic device 710 may no longer expand the image 731 having the first expansion size in a state in which the first navigation bar 721 is displayed, a margin area may increase by the additional area 760. When the size of the display screen changes, the electronic device 710 may detect a margin area located in the display screen. For example, when the electronic device 710 displays the image 731 such that the center of the image 731 matches the center of the application area 730, the margin areas 751 and 752 may be detected respectively in the left and right sides of the image 731 of the application area 730.

According to an embodiment, the electronic device 710 may determine whether to output a second navigation bar 722, based on a comparison between the margin areas 751 and 752 detected within the display screen and the second navigation bar 722. The size of the second navigation bar 722 may be preset. In other words, the length along the first axis and the length along the second axis of the second navigation bar 722 may be preset. For example, the number of pixels corresponding to the length along the first axis of the second navigation bar 722 may be preset.

The electronic device 710 may determine whether to display a second navigation bar by comparing the length along the first axis of the detected margin areas 753 and 754 with the preset first axis length of the second navigation bar 722. Specifically, the electronic device 710 may determine to display the second navigation bar 722 when the length along the first axis of the detected margin areas 753 and 754 is greater than or equal to the preset first axis length of the second navigation bar 722. In this case, the length along the first axis of a margin area may be a length obtained by summing the length along the first axis of each of the margin areas detected within the display screen. For example, as illustrated in FIG. 7, when detecting the margin area 753 on the right side and the margin area 754 on the left side based on the image 731 of the application area 730, the electronic device 710 may compare the length calculated by summing the length along the first axis of the margin area 753 and the length along the second axis of the margin area 754 with the length along the first axis of the second navigation bar 722.

In addition, the first axis length preset for the second navigation bar 722 may be a greater length of a default length preset for the second navigation bar 722 and a length required to display at least one icon included in the first navigation bar 721 within the second navigation bar 722. In this case, the preset default length may be a minimum and/or small length for displaying a second navigation bar without considering the display of an icon included in a first navigation bar. The electronic device 710 may calculate a candidate length required to display at least one icon included in the first navigation bar 721 within the second navigation bar 722. For example, when terminating an output of the first navigation bar 721 and initiating an output of the second navigation bar 722, all the icons displayed on the first navigation bar 721 may be set to be displayed on the second navigation bar 722. In this case, the electronic device 710 may calculate a minimum and/or small area required to display, on the second navigation bar 722, all the icons displayed on the first navigation bar 721, and may calculate the length along the first axis of the second navigation bar 722 based on the minimum and/or small area as a candidate length.

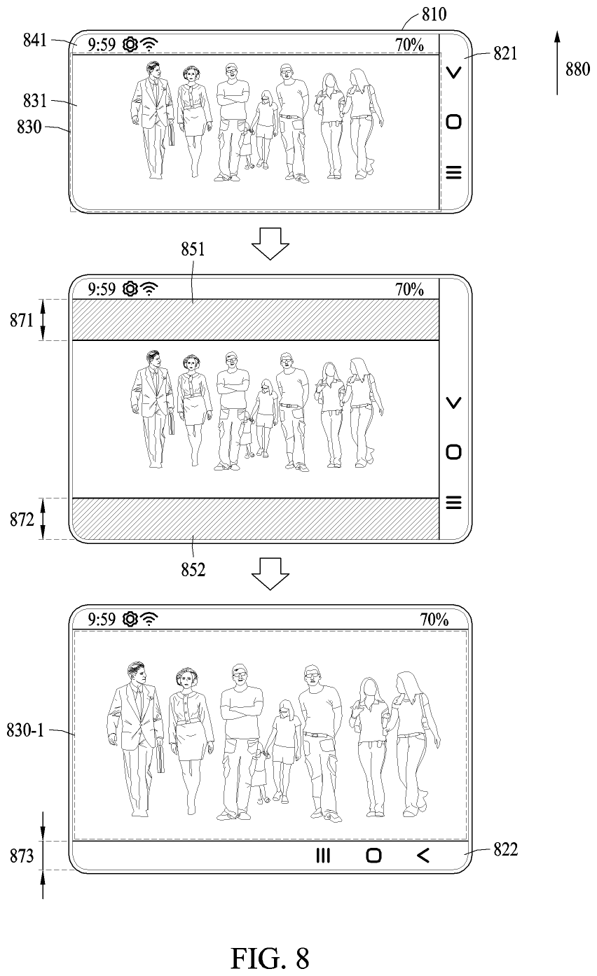

FIG. 8 is a diagram illustrating an example of image expansion in a landscape view mode, according to an embodiment.

According to an embodiment, an electronic device 810 (e.g., the electronic device 101 of FIG. 1) may be in a landscape view mode. A display screen of the electronic device 810 may expand in a first direction 880 (e.g., a direction from bottom to top). The electronic device 810, before a display screen expands, may display a first navigation bar 811, an image 831, and a notification bar 841. When the electronic device 810 is in the landscape view mode, the notification bar 841 may be displayed along a second axis and the first navigation bar 821 may be displayed along a first axis. When the display screen expands in the first direction 880, the electronic device 810 may determine whether the size of the image 831 may increase while maintaining the image ratio. As described above, when there is no margin area on the second axis (e.g., a left or right side of the image 831) based on the image 831 of the application area 830, the electronic device 810 may determine that the size of the image 831 may not increase as the display screen expands in the first direction 880.

For example, as illustrated in FIG. 8, an image ratio of the image 831 matches a screen ratio of the electronic device 510 before the display screen expands, and there may be no margin area within the display screen. When the electronic device 810 is in the landscape view mode, a status bar 810 may be displayed along the second axis and the first navigation bar 821 may be displayed along the first axis. When the display screen of the electronic device 810 expands in the first direction 880, margin areas 851 and 852 may be generated in upper and lower sides of the image 831 of the application area 830. The electronic device 810 may detect the margin areas 851 and 852, and, when the length along the first axis of the detected margin areas 851 and 852 is greater than or equal to a first axis length 873 of a second navigation bar 822, may terminate an output of the first navigation bar 821 and initiate an output of the second navigation bar 822. In this case, the length along the first axis of the margin areas 851 and 852 may be a length obtained by summing a length 871 along the first axis of the margin area 851 and the length along the first axis of the margin area 852.

According to an embodiment, the electronic device 810 may terminate the output of the first navigation bar 821 and initiate the output of the second navigation bar 822. When outputting the second navigation bar 822, the electronic device 810 may designate, as an expanded application area 830-1, a remaining area excluding an area where the second navigation bar 822 is displayed and an area where the status bar 841 is displayed within the display screen. When determining to output the second navigation bar 822, the electronic device 810 may display the second navigation bar 822 in a preset size and may expand and display the image 831 in the application area 830-1.

When the image 831 displayed in the expanded application area 830-1 upon outputting the second navigation bar 822 has a second expansion size, which is a maximum expandable size of an image while the second navigation bar 822 is displayed, the electronic device 810 may maintain the size of the image 831 in the second expansion size as the display screen of the electronic device further expands, and a margin area may be additionally generated on the first axis based on the image 831. On the other hand, when the image 831 displayed in the expanded application area 830-1 upon outputting the second navigation bar 822, the electronic device 810 may further expand the size of the image 831 as the display screen of the electronic device further expands, for example, may increase the size of the image 831 until the size of the image 831 reaches the second expansion size.

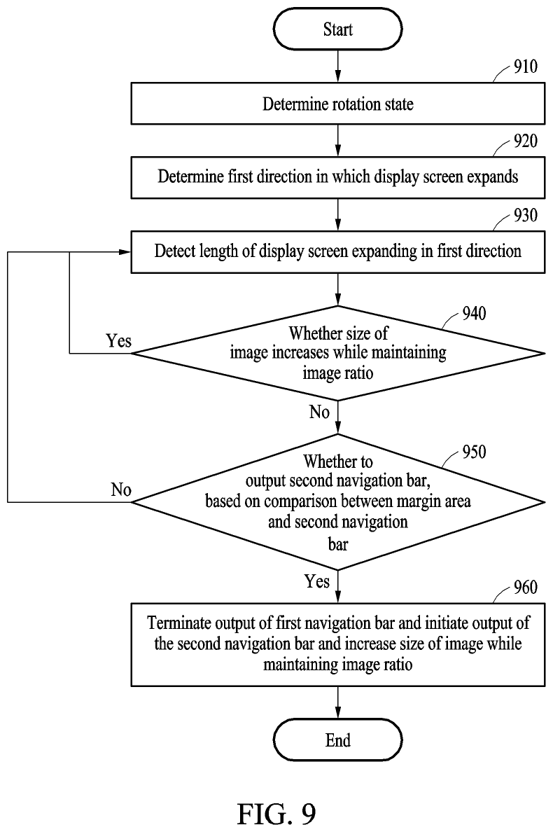

FIG. 9 is a flowchart illustrating an operation of an electronic device expanding an image, according to an embodiment.

In operation 910, an electronic device (e.g., the electronic device 101 of FIG. 1) according to an embodiment may determine a rotation state of the electronic device. For example, the electronic device may determine the rotation state of the electronic device to be one of a landscape or portrait view mode. The electronic device may display a notification bar and a first navigation bar based on the determined rotation state. For example, when determining the rotation state to be the landscape view mode, the electronic device may display the first navigation bar along a first axis and the notification bar along a second axis.

In operation 920, the electronic device may determine a first direction in which the display screen expands. For example, when the electronic device is in the portrait view mode, the first direction may be a direction from left to right or a direction from right to left. For another example, when the electronic device is in the landscape view mode, the first direction may be a direction from bottom to top or a direction from top to bottom.

Then, in operation 930, the electronic device may detect the length of the display screen expanding in the first direction. For example, the electronic device may drive a motor and automatically expand the display screen of the electronic device in the first direction. For another example, the display screen of the electronic device may be manually expanded by an external force of a user. Then, the electronic device may detect the length of the display screen expanding in the first direction.

In operation 940, when the display screen expands in the first direction, the electronic device may detect the length of the display screen expanding in the first direction and may determine whether the size of the image may increase while maintaining an image ratio in a state in which the first navigation bar is displayed. For example, the electronic device may calculate a screen ratio of the electronic device, based on the length of the display screen expanding in the first direction. By comparing the screen ratio of the electronic device with the image ratio, as the display screen expands, the electronic device may determine whether the size of the image may increase while maintaining the image ratio in a state in which the first navigation bar is displayed. In other words, the electronic device may determine whether the image has a first expansion size, which is a maximum expandable size of the image while the first navigation bar is displayed. When the image has a size less than the first expansion size, the electronic device may determine the image may further expand while the first navigation bar is displayed through the additional expansion of the display screen, may return to operation 930, and may detect the length of the display screen additionally expanding in the first direction.

In operation 950, when determining the image to have the first expansion size, the electronic device may detect a margin area located within the display screen and may determine whether to output a second navigation bar, based on a comparison between the detected margin area and the second navigation bar. When determining that the second navigation bar may not be output based on the comparison between the margin area and the second navigation bar, the electronic device may determine that the second navigation bar may be output when expanding the margin area through the additional expansion of the display screen, may return to operation 930, and may detect an extending length as the display screen additionally expands in the first direction.

In operation 960, when determining to output the second navigation bar, the electronic device may terminate an output of the first navigation bar and initiate an output of the second navigation bar. In addition, the electronic device may increase the size of the image while maintaining the image ratio of the image in the display screen. The electronic device may initiate the output of the second navigation bar and may increase the size of the image while maintaining the image ratio by using a first navigation bar area where the first navigation bar has been displayed. The electronic device may expand and display the image in a remaining application area excluding an area where the second navigation bar is displayed and an area where the notification bar is displayed within the displayed screen.

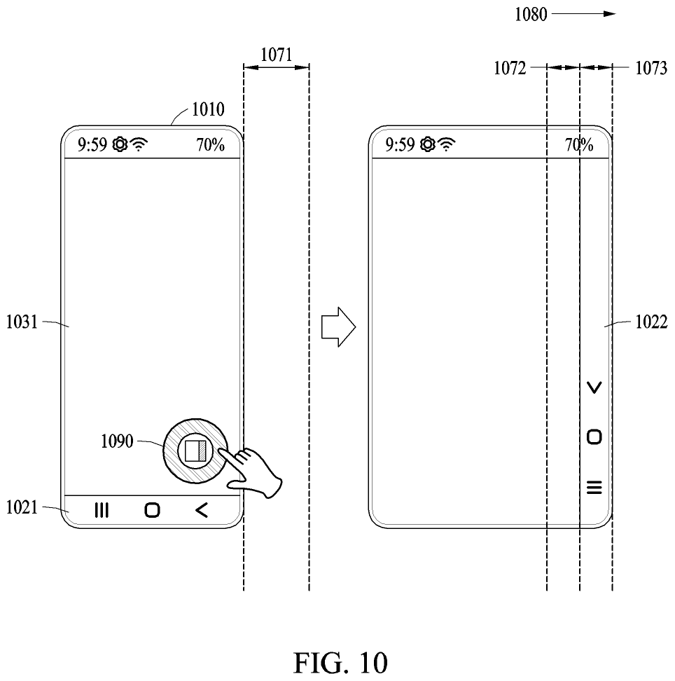

FIG. 10 is a diagram illustrating image expansion based on a user input, according to an embodiment.

According to an embodiment, an electronic device 1010 (e.g., the electronic 101 of FIG. 1) may expand a display screen in a first direction such that an image 1031 has a second expansion size, based on a user input requesting the expansion of the image 1031 to the second expansion size.

For example, as illustrated in FIG. 10, the electronic device 1010 may output an object 1090, which indicates the expansion of the image 1031 to the second expansion size, on the display screen. The object 1090 may be a pop-up icon representing an operation of expanding the size of the display screen of a display module. In response to a user input of selecting the object 1090, the electronic device 1010 may expand the display screen in a first direction 1080 such that the image 1031 has the second expansion size.

The electronic device 1010 may expand the display screen by a second expansion length 1071 in the first direction 1080 such that the image 1031 has the second expansion size. The second expansion length 1071 may be a minimum and/or small expansion length in the first direction 1080 of the display screen such that the image 1031 has a maximum expandable size while maintaining an image ratio in a state in which a first navigation bar 1021 is deleted and a second navigation bar 1022 is displayed.

When expanding the display screen by the second expansion length 1071, the electronic device 1010 may expand the image 1031 such that the length along a second axis of the image 1031 is a length obtained by subtracting the length along the second axis of a notification bar from the length along the second axis of the display screen. For example, the second expansion length 1071 may be a length obtained by summing a length 1072 obtained by subtracting a length along a first axis of an image before expansion from a length along the first axis of an image expanded to the second expansion size and the length 1072 along the first axis of the second navigation bar 1022. For example, based on the user input requesting the expansion of the image 1031 to the second expansion size, the electronic device 1010 may drive a motor and expand the display screen by the second expansion length 1071 in the first direction.

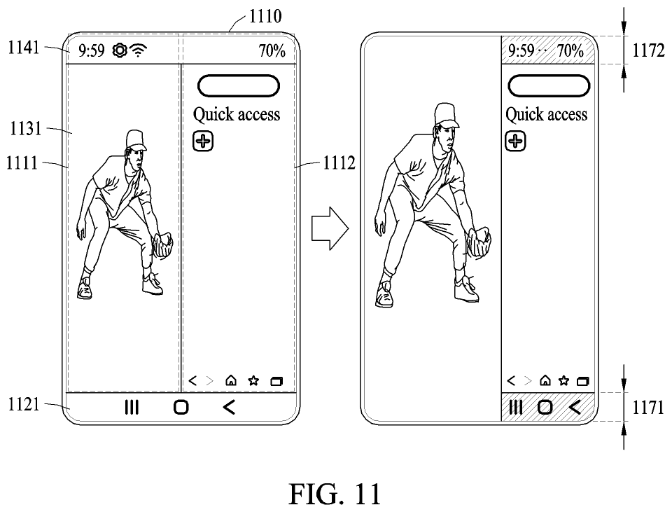

FIG. 11 is a diagram illustrating image expansion in a multi-window environment, according to an embodiment.

According to an embodiment, an electronic device 1110 (e.g., the electronic device 101 of FIG. 1) may expand an image in a multi-window environment. As illustrated in FIG. 11, the electronic device 1110 may generate a plurality of windows (e.g., a first window 1111 or a second window 1112). The electronic device 1110 may display an image 1131 on the first window 1111.

When displaying the image 1131 on the first window 1111 and separately generating the second window 1112 distinguished from the first window 1111, the electronic device 1110 may terminate an output of a first navigation bar 1121 on the first window 1111 and may maintain the output of the first navigation bar 1121 on the second window 1112. The electronic device 1110 may use an area where the first navigation bar 1121 has been displayed on the first window 1111 to increase the size of the image 1131 while maintaining an image ratio. In addition, the electronic device 1110 may terminate an output of a notification bar 1141 in the first window 1111, may maintain the output of the notification bar 1141 in the second window 1112, and may use an area where the notification bar 1141 has been displayed on the first window 1111 to increase the size of the image 1131 while maintaining the image ratio.

For example, the electronic device 1110 may display the image 1131 in a portion of the area where the first navigation bar 1121 has been displayed and a portion of the area where the notification bar 1141 has been displayed on the first window 1111. The electronic device 1110 may increase the size of the image 1131 such that the length along a second axis of the image 1131 may become the length along the second axis of the display screen. In other words, the electronic device 1110 may increase the size of the image 1131 while maintaining the image ratio such that the length along the second axis of the image 1131 may increase to a length 1171 along the second axis of the area where the first navigation bar 1121 has been displayed on the first window 1111 and a length 1172 along the second axis of the area where the notification bar 1141 has been displayed on the first window 1111.

The electronic device 1110, by expanding an area occupied by the first window 1111 and reducing an area occupied by the second window 1112, may expand the size of the image 1131 while maintaining the image ratio.

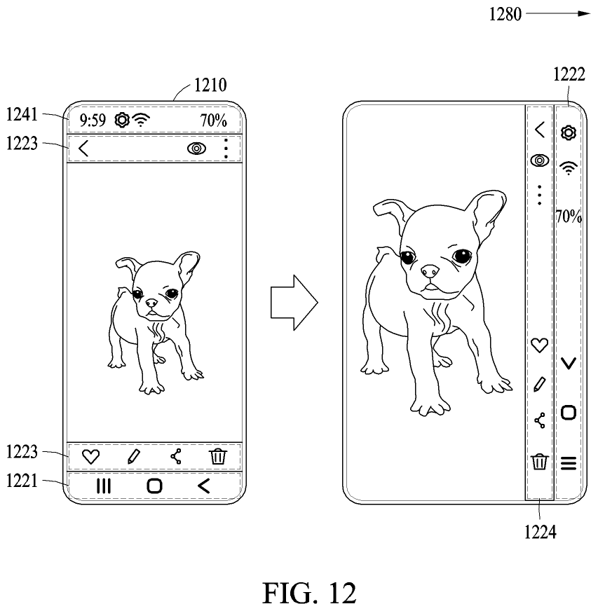

FIG. 12 is a diagram illustrating a method of further expanding an image, according to an embodiment.

According to an embodiment, an electronic device 1210 (e.g., the electronic device 101 of FIG. 1), when executing an application, may output an application control panel (e.g., a first application control panel 1223 or a second application control panel 1224) for controlling the application on a display screen. The electronic device 1210 may display an image 1231 in an area excluding an area where a first navigation bar 1221 is displayed, an area where a notification bar 1241 is displayed, and an area where the first application control panel 1223 is displayed within the display screen. For example, a first application control panel may be an application control panel displayed along a first axis, which may be displayed such that a length along the first axis is greater than a length along a second axis. A second application control panel may be an application control panel displayed along the second axis, which may be displayed such that the length along the first axis is less than the length along the second axis. When the first application control panel is output, the second application control panel may not be output, and, conversely, when the second application control panel is output, the first application control panel may not be output.

To expand the image 1231, the electronic device 1210 may terminate an output of the first navigation bar 1221 and may initiate an output of the second navigation bar 1222. For example, the electronic device 1210 may display, on the second navigation bar 1222, at least one icon displayed on the first navigation bar 1221. To further expand the image 1231, the electronic device 1210 may terminate an output of the notification bar 1241 and may display, on the second navigation bar 1222, at least one icon displayed on the notification bar 1241. When terminating the output of the notification bar 1241, the electronic device 1210 may extend a length along the second axis of an image by a length along the second axis of an area where the notification bar 1241 is displayed and may expand the image while maintaining an image ratio.

In addition, the electronic device 1210 may terminate an output of the first application control panel 1223 and initiate an output of the second application control panel 1224 to increase the size of the image 1231. The electronic device 1210 may display, on the second application control panel 1224, at least one icon displayed on the first application control panel 1223. The size of the second application control panel 1224 may be preset.

The electronic device 1210 may detect a margin area generated when the display screen expands in a first direction 1280. When the length along the first axis of the margin area is greater than or equal to a length obtained by summing the length along the first axis of the second navigation bar 1222 and the length along the first axis of the second application control panel 1224, the electronic device 1210 may terminate the output of the first navigation bar 1221 and initiate the output of the second navigation bar 1222 and may terminate the output of the first application control panel 1223 and initiate the output of the second application control panel 1224. In addition, when the length along the first axis of the margin area is greater than or equal to the length along the first axis of the second navigation bar 1222, the electronic device 1210 may maintain the output of the first application control panel 1223 while terminating the output of the first navigation bar 1221 and initiating the output of the second navigation bar 1222.

Furthermore, the electronic device 1210 may determine a method of expanding the image 1231 based on a resolution of the image 1231. The electronic device 1210 may verify the resolution of the image 1231 output on the display screen. When the resolution of the image 1231 is not degraded despite the expansion of the image 1231, the electronic device 1210 may expand the image 1231 according to the expansion of the display screen while maintaining the image ratio. For example, when the display screen expands, and a resolution of an expanded application area is less than or equal to the resolution of the image 1231, the electronic device 1210 may expand the image 1231 while maintaining the image ratio. For another example, when the display screen expands, and the resolution of the expanded application area exceeds the resolution of the image 1231, the electronic device 1210 may expand the image 1231 up to a size corresponding to the resolution of the image. Yet another example, when the display screen expands, the resolution of the expanded application area exceeds the resolution of the image 1231, and the degradation of the resolution of the image 1231 is expected, the electronic device 1210 may perform up-scaling to prevent or reduce the resolution degradation when expanding the image 1231 to a size matching the expanded application area. In this case, when the display screen expands, the electronic device 1210 may display an up-scaled image by matching the expanded application area.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, an electronic device may include a display module, comprising a display, configured to change a size of a display screen, a memory configured to store computer-executable instructions, and a processor, comprising processing circuitry, configured to execute the computer-executable instructions by accessing the memory, in which the processor is further configured to, when the size of the display screen changes while displaying an image and a first navigation bar, terminate an output of the first navigation bar and initiate an output of a second navigation bar and change a size of the image while maintaining an image ratio.

The processor, when the size of the display screen changes, may detect a margin area located in the display screen, and may determine whether to output the second navigation bar, based on a comparison between the detected margin area and the second navigation bar.

The processor, when the image has a first expansion size representing a maximum or high expandable size of the image while maintaining the image ratio in a state in which the first navigation bar is displayed, may compare the detected margin area with the second navigation bar.

The processor, when determining to output the second navigation bar, may expand the image to a second expansion size such that a length along a second axis of the image having the first expansion size expands to a length along a second axis of an area where the first navigation bar was displayed while maintaining the image ratio, and a first axis is an axis that is parallel to a direction in which the display screen expands, and the second axis is an axis that is orthogonal to the first axis.

The processor, when determining to output the second navigation bar, may output the second navigation bar by using the detected margin area.

The processor, when a length along a first axis of the detected margin area is greater than or equal to a first axis length of the second navigation bar, may determine to output the second navigation bar.

The first axis length of the second navigation bar may be a greater length of a default length preset for the second navigation bar and a length required to display at least one icon included in the first navigation bar within the second navigation bar.

The processor, at a time at which the second navigation bar is output, when the image has the second expansion size representing a maximum or high expandable size of the image in a state in which the second navigation bar is displayed, may maintain the size of the image as the display screen is further expanded, and, at a time at which the second navigation bar is output, when the image has a size less than the second expansion size, may further expand the size of the image as the display screen is further expanded.

The processor, in a state when the second navigation bar of the image is displayed, based on a user input requesting the expansion to the second expansion size representing a maximum or high expandable size of the image, may expand the display screen in a first direction such that the image has the second expansion size.

“Based on” as used herein covers based at least on.

The processor, when displaying the image on a first window and separately generating a second window distinguished from the first window, may terminate the output of the first navigation bar in the first window, may maintain the output of the first navigation bar in the second window, and may expand the size of the image while maintaining the image ratio by using the area where the first navigation bar was displayed on the first window.

The processor, by expanding an area occupied by the first window and reducing an area occupied by the second window, may expand the size of the image while maintaining the image ratio.

The processor, when a resolution of the image is not degraded according to the expansion of the image, based on the expansion of the display screen, may expand the image while maintaining the image ratio.

According to an embodiment, a method implemented by a processor may include displaying an image and a first navigation bar, when a size of a display screen of a display module changes while displaying the image and the first navigation bar, terminating an output of the first navigation bar and initiating an output of a second navigation bar, and changing a size of the image while maintaining an image ratio on the display screen.

The initiating of the output of the second navigation bar may include, when the size of the display screen changes, detecting a margin area located in the display screen, and determining whether to output the second navigation bar, based on a comparison between the detected margin area and the second navigation bar.

The determining of whether to output the second navigation bar may include, when the image has a first expansion size representing a maximum or high expandable size of the image while maintaining the image ratio in a state in which the first navigation bar is displayed, comparing the detected margin area with the second navigation bar.

According to an embodiment, a method implemented by a processor further may include, when determining to output a second navigation bar, expanding an image to a second expansion size such that a length along a second axis of the image having a first expansion size expands to a length along a second axis of an area where a first navigation bar was displayed while maintaining an image ratio, and a first axis is an axis that is parallel to a direction in which a display screen expands, and the second axis is an axis that is orthogonal to the first axis.

The method implemented by the processor may further include, when determining to output the second navigation bar, outputting the second navigation bar by using the detected margin area.

The determining of whether to output the second navigation bar may include, when a length along a first axis of the detected margin area is greater than or equal to a first axis length of the second navigation bar, determining to output the second navigation bar.

The method implemented by the processor may further include, in a state when the second navigation bar of the image is displayed, based on a user input requesting the expansion to the second expansion size representing a maximum or high expandable size of the image, expanding the display screen in a first direction such that the image has the second expansion size.

The method implemented by the processor may further include, when displaying the image on a first window and separately generating a second window distinguished from the first window, terminating the output of the first navigation bar in the first window, maintaining the output of the first navigation bar in the second window, and expanding the size of the image while maintaining the image ratio by using the area where the first navigation bar was displayed on the first window.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein

1. An electronic device comprising:
a display module, comprising a display, configured to change a size of a display screen;
a memory configured to store computer-executable instructions; and
at least one processor, comprising processing circuitry, individually and/or collectively configured to execute the computer-executable instructions by accessing the memory, and to:
when the size of the display screen changes while displaying an image and a first navigation bar, terminate an output of the first navigation bar and initiate an output of a second navigation bar and change a size of the image while maintaining an image ratio.

2. The electronic device of claim 1, wherein at least one processor is individually and/or collectively configured to,
when the size of the display screen changes, detect a margin area located in the display screen, and determine whether to output the second navigation bar, based on a comparison between the detected margin area and the second navigation bar.

3. The electronic device of claim 1, wherein at least one processor is individually and/or collectively configured to,
when the image has a first expansion size representing a maximum and/or high expandable size of the image while maintaining the image ratio in a state in which the first navigation bar is displayed, compare the detected margin area with the second navigation bar.

4. The electronic device of claim 1, wherein at least one processor is individually and/or collectively configured to,
when determining to output the second navigation bar, expand the image to a second expansion size such that a length along a second axis of the image having the first expansion size expands to a length along a second axis of an area where the first navigation bar was displayed while maintaining the image ratio, and
a first axis is an axis that is parallel to a direction in which the display screen expands, and the second axis is an axis that is orthogonal to the first axis.

5. The electronic device of claim 1, wherein at least one processor is individually and/or collectively configured to,
when determining to output the second navigation bar, output the second navigation bar by using at least the detected margin area.

6. The electronic device of claim 1, wherein at least one processor is individually and/or collectively configured to,
when a length along a first axis of the detected margin area is greater than or equal to a first axis length of the second navigation bar, determine to output the second navigation bar.

7. The electronic device of claim 1, wherein
the first axis length of the second navigation bar is a greater length of a default length preset for the second navigation bar and a length to display at least one icon comprised in the first navigation bar within the second navigation bar.

8. The electronic device of claim 1, wherein at least one processor is individually and/or collectively configured to,
at a time at which the second navigation bar is output, when the image has the second expansion size representing a maximum and/or high expandable size of the image in a state in which the second navigation bar is displayed, maintain the size of the image as the display screen is further expanded, and,
at a time at which the second navigation bar is output, when the image has a size less than the second expansion size, further expand the size of the image as the display screen is further expanded.

9. The electronic device of claim 1, wherein at least one processor is individually and/or collectively configured to,
in a state when the second navigation bar of the image is displayed, based on a user input requesting the expansion to the second expansion size representing a maximum and/or high expandable size of the image, expand the display screen in a first direction such that the image has the second expansion size.

10. The electronic device of claim 1, wherein at least one processor is individually and/or collectively configured to,
when displaying the image on a first window and separately generating a second window distinguished from the first window, terminate the output of the first navigation bar in the first window, maintain the output of the first navigation bar in the second window, and expand the size of the image while maintaining the image ratio by using at least the area where the first navigation bar was displayed on the first window.

11. The electronic device of claim 1, wherein at least one processor is individually and/or collectively configured to,
by expanding an area occupied by the first window and reducing an area occupied by the second window, expand the size of the image while maintaining the image ratio.

12. The electronic device of claim 1, wherein at least one processor is individually and/or collectively configured to,
when a resolution of the image is not degraded according to the expansion of the image, based on the expansion of the display screen, expand the image while maintaining the image ratio.

13. A method implemented by a processor, the method comprising:
displaying an image and a first navigation bar;
when a size of a display screen of a display module changes while displaying the image and the first navigation bar, terminating an output of the first navigation bar and initiating an output of a second navigation bar; and
changing a size of the image while maintaining an image ratio on the display screen.

14. The method of claim 13, wherein the initiating the output of the second navigation bar comprises:
when the size of the display screen changes, detecting a margin area located in the display screen; and
determining whether to output the second navigation bar, based on a comparison between the detected margin area and the second navigation bar.

15. The method of claim 13, wherein
the determining whether to output the second navigation bar comprises:
when the image has a first expansion size representing a maximum expandable size of the image while maintaining the image ratio in a state in which the first navigation bar is displayed, comparing the detected margin area with the second navigation bar, and
the changing the size of the image comprises:
when determining to output the second navigation bar, expanding the image to a second expansion size such that a length along a second axis of the image having the first expansion size expands to a length along a second axis of an area where the first navigation bar was displayed while maintaining the image ratio.
